(19) United States
(12) Patent Application Publication
(10) Pub. No.: US 2002/0133271 A1
(43) Pub. Date: Sep. 19, 2002

(54) Virtual odometer system and method

(75) Inventors: Paul Joseph McDermott, (US); Jerry Arnston Farmer, (US)

Correspondence Address: Dale B. Halling, Law Office of Dale B. Halling, LLC, 24 S. Weber St., Suite 311, Colorado Springs, CO, 80903, US

(73) Assignee: National Systems & Research Co.

(21) Appl. No.: 09/804,915

(22) Filed: Mar. 13, 2001

(51) Int. Cl. G06F 17/00

(52) U.S. Cl. 701/1; 701/93

(57) ABSTRACT

A virtual odometer system (10) combines a speed sensor (12), a processor (14), a communication interface (16), a wireless communication system (18) and a monitoring location (20) to determine and report mileage data. The speed sensor (12) provides speed data to a processor (14). The communication interface (16) connects the processor (14) to the wireless communication system (18). The wireless communication system (18) transmits the odometer data to a monitoring location (20).

### FIELD OF THE INVENTION

The present invention relates generally to the field of distance measuring systems and more particularly to a virtual odometer system and method.

### BACKGROUND OF THE INVENTION

Numerous types of vehicles require maintenance at predetermined mileage intervals. Some of these vehicles, like fleet vehicles or over-the-road trucks, are not frequently available for a mileage inspection at a maintenance facility. This inability to know a vehicle's mileage on a regular basis may result in a vehicle missing its required maintenance. Magnifying the problem, many of the vehicles' odometers are not properly calibrated or are simply broken. In addition, some existing odometer systems use global positioning system (GPS) receivers to directly measure the distance traveled. Such systems may encounter excessive error when operating at low speeds or over short distances. This error results from the accuracy limitations inherent in all GPS measurements. This is sometimes called circular error. Due to these problems, mileage information from these vehicles is either unreliable or unavailable.

Thus there exists a need for a system that can accurately determine the mileage of a vehicle and can transmit the mileage information reliably anywhere it is required.

### BRIEF DESCRIPTION OF THE DRAWINGS

FIG. 1 is a block diagram of a distance measuring system in accordance with one embodiment of the invention;

FIG. 2 is a flow chart of the steps used by a distance measuring system in accordance with one embodiment of the invention;

FIG. 3 is a flow chart of the steps used by a distance measuring system in accordance with one embodiment of the invention;

FIG. 4 is a time line depicting the steps used by a distance measuring system in accordance with one embodiment of the invention; and

FIG. 5 is a time line depicting the steps used by a distance measuring system in accordance with one embodiment of the invention.

### DETAILED DESCRIPTION OF THE DRAWINGS

The present invention combines; a speed sensor, a processor, a communication interface, a wireless communication system and a monitoring location to determine and report mileage data. The speed sensor provides speed data. The processor receives the speed data. The communication interface connects the processor to the wireless communication system. The wireless communication system transmits the odometer data to the monitoring location. In one embodiment the speed sensor is a global positioning system (GPS) receiver. The speed sensor could also be a radar or laser speed-measuring device. In another embodiment, the processor includes an algorithm to convert the speed signal into odometer data. The system may also be set up to compensate for periods of lost GPS signals. In another embodiment, the monitoring location includes an automated alerting system. This system allows continuous or scheduled odometer updates from all of a company's vehicles, and permits a vehicle to be directed to a maintenance facility.

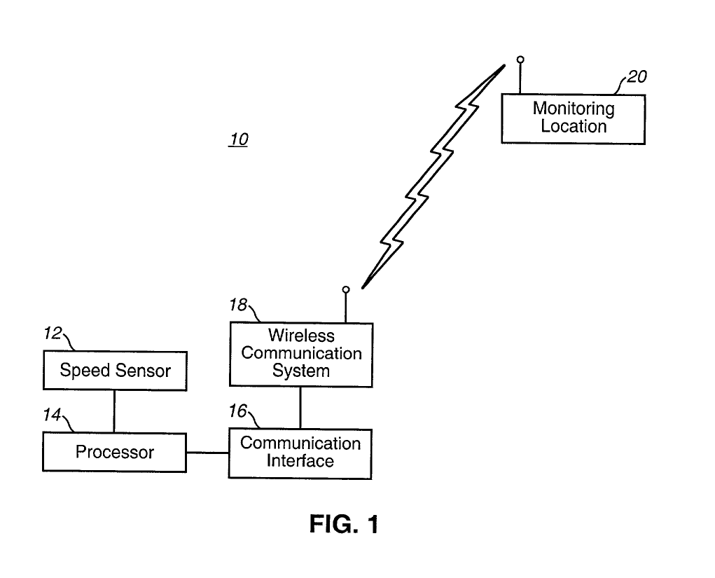

FIG. 1 is a block diagram of a distance measuring system 10 in accordance with one embodiment of the invention. A speed sensor 12 supplies a speed signal to a processor 14. A communication interface 16 connects the processor 14 to a wireless communication system 18. The wireless communication system 18 transmits a plurality of odometer data to a monitoring location 20. In one embodiment, the speed sensor 12 is a GPS receiver. In another embodiment, the speed sensor is a radar or laser system. In another embodiment, the processor 14 uses an algorithm to convert the speed data into odometer data. In another embodiment, the monitoring location 20 includes an automated alerting system. This permits the remote monitoring of a vehicle, and also permits a vehicle to be directed to a maintenance facility.

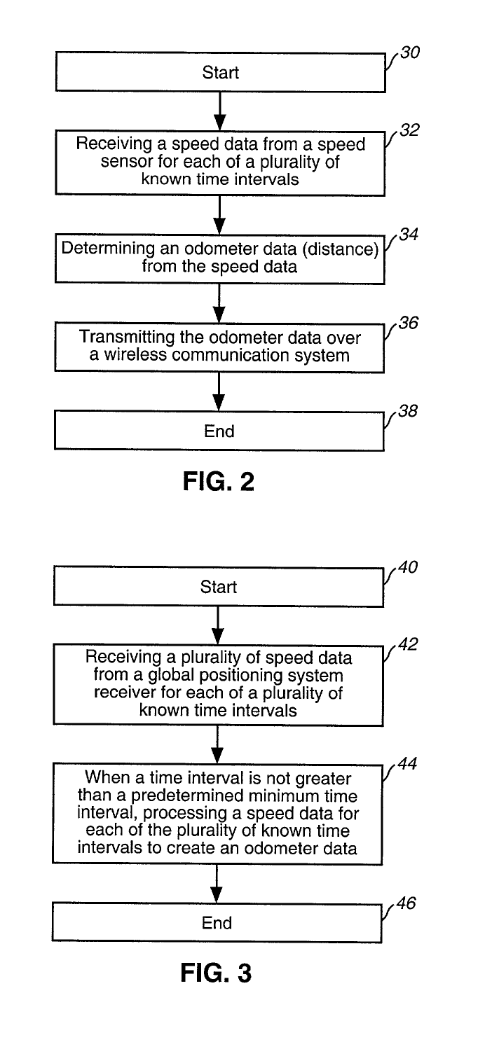

FIG. 2 is a flow chart of the steps used by a distance measuring system in accordance with one embodiment of the invention. The process starts at step 30, where the system receives a speed data from a speed sensor for each of a plurality of known time intervals at step 32. At step 34, the system determines an odometer data from the speed data. At step 36, the system transmits the odometer data over a wireless communication system, which ends the process at step 38. In one embodiment, the system multiplies the speed data by a time factor for each of the plurality of known time intervals to form a plurality of distance measurements, and sums the plurality of distance measurements to form the odometer data. In another embodiment, the system determines if the odometer data exceeds a predetermined value, and when the odometer data exceeds the predetermined value, the system activates an automated alerting system. In another embodiment, the system receives the speed data from a global positioning system receiver. In another embodiment, the system determines if a time interval between a successive speed data is greater than a predetermined maximum time interval, and when the time interval between the successive speed data is greater than the predetermined maximum time interval, determining a distance between a last known position and a subsequent position. Then the system replaces the last known position with the subsequent position. In another embodiment, the system determines if the time interval between the successive speed data is greater than a predetermined minimum time interval and is not greater than the predetermined maximum time interval, and when the time interval between the successive speed data is greater than the predetermined minimum time interval and is not greater than the predetermined maximum time interval, the system averages a last known position speed data with a subsequent position speed data to produce an average speed data. In another embodiment, the system multiplies the average speed data by the time interval between the successive speed data. In another embodiment, the system receives an engine signal and determines if a time interval between a successive speed data is greater than a predetermined minimum time interval. When the time interval between the successive speed data is greater than the predetermined minimum time interval, the system averages a last known speed data with a successive speed data to create an average speed data. The system then multiplies the average speed data by the time interval between the last known speed data and the successive speed data to derive the odometer data. In another embodiment, the system receives an engine on signal. In another embodiment, the system receives an engine off signal. The engine on signal directs the system to start deriving odometer data. The engine off signal directs the system to stop acquiring odometer data.

FIG. 3 is a flow chart of the steps used by a distance measuring system in accordance with one embodiment of the invention. The process starts, step 40, with the system receiving a plurality of speed data from a global positioning system receiver for each of a plurality of known time intervals at step 42. When a time interval is not greater than a predetermined minimum time interval, at step 44 the system sums a speed data for each of the plurality of known time intervals to create an odometer data, ending the process at step 46. In one embodiment, the system sends the plurality of speed data over a wireless communication system. In another embodiment, the system sends an odometer data over a wireless communication system. The system determines if a GPS signal is lost, and when the GPS signal is lost, the system determines when the GPS signal is reacquired. When the GPS signal is reacquired, the system determines the distance between a last known position and a reacquired position. At any one time, the system has a GPS position stored in its memory. The stored position is the position corresponding to the speed data immediately preceding the current speed data. As new speed data, and the corresponding position data, are acquired, the stored data is discarded and then replaced with the newest data, so that there is only one position stored at any time.

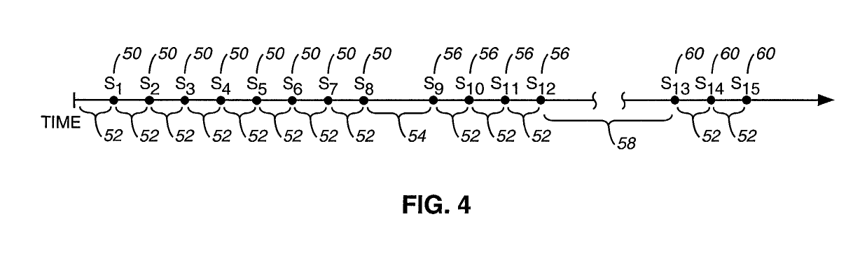

FIG. 4 is a time line depicting the steps used by a distance measuring system in accordance with one embodiment of the invention. Speed data points S1-S15 depict a plurality of speed data points that demonstrate the flexibility of this distance measuring system. S1-S8 depict a plurality of speed data points 50 received by the system at a regular, known interval 52. The regular interval 52 between the data points permits a simple algorithm to convert the speed data into distance data. Such an algorithm permits the plurality of speed data to be summed and then the sum is multiplied by a conversion factor to derive the odometer data. A regular time interval allows the system to apply a single conversion factor after a plurality of speed data are summed, resulting in a significant savings of memory and processing capability. This results in a very quick and efficient computation process that uses a minimum of the limited processor and memory resources.

The space between speed data points S8 and S9 represents a time interval 54 that is greater than the predetermined minimum time interval and not greater than the predetermined maximum time interval. This situation may occur when GPS signals are lost in an urban canyon environment. When the time interval is greater than the predetermined minimum time interval and not greater than the predetermined maximum time interval, the system averages the speed data from S8 and S9 and applies the time interval between S8 and S9 to derive the distance between S8 and S9. That distance between the two points is added to the distance derived from speed data S1-S8. When measured with a GPS receiver, this error is particularly acute for low speeds and short distances.

A user may define the predetermined minimum and maximum time intervals. Typically, the predetermined minimum time interval is the same as the regular, known time interval 52. The predetermined maximum time interval will be a longer interval, e.g., 20 seconds. However, since the system simply averages the speed data from S8 and S9, any changes in speed during the predetermined maximum time interval will not be factored into the average. Thus, any changes in speed between S8 and S9, other than a linear speed change or no change at all, will introduce error into the calculated distance. Limiting the predetermined maximum time interval to a smaller time interval results in less likelihood of a speed change occurring between S8 and S9, and less likelihood of error being introduced when the distance between S8 and S9 is calculated.

The plurality of speed data points 56, S9-S12, represents a period when the speed data is reacquired. The speed data points are acquired at a regular, known time interval 52. The distance between S9-S12 is computed in the same manner as the distance between S1-S8. This distance is added to the existing distance total.

The space between S12 and S13 represents a time interval 58 that is greater than the predetermined maximum time interval. This represents an extended period of lost GPS signals. This may be due to an urban canyon environment or the vehicle entering an enclosure, such as a garage or loading dock. When the time interval is greater than the predetermined time interval, the system compares the GPS position that corresponds to S12 with the GPS position that corresponds to S13 to derive a linear distance. The linear distance between the two points is added to the distance derived from the previous distance total derived from speed data points S1-S12. When the system has computed the linear distance between S12 and S13, the GPS position corresponding to S12 is discarded. Since this system uses speed data to compute distance, except where the speed data is unavailable, the memory-consuming retention of extra GPS position data is unnecessary. Where speed information is unavailable, the system needs only two pieces of GPS position data: the position information for the current position and the position corresponding to the immediately preceding speed data. Any position information beyond that period is discarded.

The plurality of speed data points 60, S13-S15, represents a period when the speed data is reacquired. The speed data points are acquired at a regular, known time interval 52. The distance between S13-S15 is computed in the same manner as the distance between S1-S8. This distance is added to the previous distance sum to derive the odometer data.

The system may be programmed to transmit the odometer data at a regular time interval, on a continuous basis, when the engine is turned off, or at any other desired interval or event.

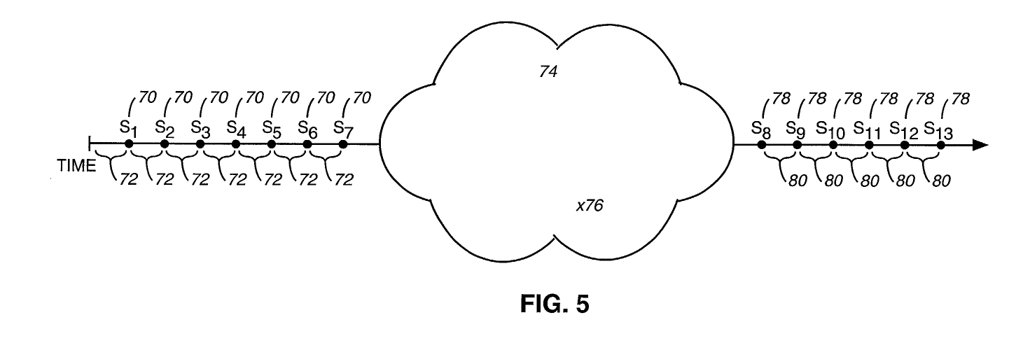

FIG. 5 is a time line depicting the steps used by a distance measuring system in accordance with one embodiment of the invention. Speed data points S1-S7 depict a plurality of speed data points 70 received by the system at a regular, known interval 72. The regular interval 72 between the data points permits a simple algorithm to convert the speed data into distance data. Such an algorithm permits the plurality of speed data to be summed and multiplied by a conversion factor to derive the odometer data. A regular time interval allows the system to apply a single conversion factor after a plurality of speed data are summed, resulting in a significant savings of memory and processing capability. The lost GPS signal area 74 may be a garage or loading dock. A vehicle in a garage or loading dock may remain in that area for a time period that is greater than the predetermined maximum time interval. If the vehicle exits the GPS signal lost area 74 at the same place it entered, the distance the vehicle traveled inside the GPS signal lost area 74 will be unaccounted for. Averaging the speed data between the entry and exit points may be inaccurate as well. A vehicle in a garage or a loading dock area may be required to turn off its engine once it is parked in parking spot 76. An engine off signal directs the system to cease its attempts to acquire speed data. Since the vehicle will not have received any speed data since it entered the GPS signal lost area 74, the distance total will be inaccurate. To compensate for the inaccuracy, the system averages the last known speed data, S7, with zero. This average is applied to the time between the last known speed data, S7, and the key off signal to derive a distance measurement that is added to the odometer data.

A key on signal performs the same process. At the key on signal, the system attempts to acquire speed data. When the system exits the GPS signal lost area 74, it acquires speed data. The time between the key on signal and the first acquired speed data, S8, is applied to the average of speed data S8 and zero to derive a distance. The distance is added to the odometer data. Once the system is out of the GPS signal lost area 74, the system receives subsequent speed data points 78. Where GPS signal coverage is adequate, the system will receive speed data points at a regular, known interval 80, saving memory and processor capability and reducing power consumption.

The methods described herein can be implemented as computer-readable instructions stored on a computer-readable storage medium that when executed by a computer will perform the methods described herein.

While the invention has been described in conjunction with specific embodiments thereof, it is evident that many alterations, modifications, and variations will be apparent to those skilled in the art in light of the foregoing description. Accordingly, it is intended to embrace all such alterations, modifications, and variations in the appended claims.

what is claimed is:

1. A virtual odometer device, comprising:
a speed sensor;
a processor for receiving a speed signal from the speed sensor;
a communication interface connecting the processor to a wireless communication system, the wireless communication system designed to transmit a plurality of the odometer data; and
a monitoring location to receive the odometer data.

2. The virtual odometer device of claim 1, wherein the speed sensor is a global positioning system receiver.

3. The virtual odometer device of claim 1, wherein the processor includes an algorithm to convert the speed signal into the odometer data.

4. The virtual odometer device of claim 1, wherein the monitoring location includes an automated alerting system.

5. A method of operating a virtual odometer system, comprising the steps of:
(a) receiving a speed data from a speed sensor for each of a plurality of known time intervals;
(b) determining an odometer data from the speed data;
(c) transmitting the odometer data over a wireless communication system.

6. The method of claim 5, wherein step (b) includes the steps of:
(b1) multiplying the speed data by a time factor for each of the plurality of known time intervals to form a plurality of distance measurements;
(b2) summing the plurality of distance measurements to form the odometer data.

7. The method of claim 5, wherein step (b) includes the steps of:
(b1) summing the speed data.

8. The method of claim 5, further including:
(d) determining if the odometer data exceeds a p1 predetermined value;
(e) when the odometer data exceeds the predetermined value, activating an automated alerting system.

9. The method of claim 5, wherein step (a) includes the steps of:
(a1) receiving the speed data from a global positioning system receiver.

10. The method of claim 5, wherein step (b) includes the steps of:
(b1) determining if a time interval between a successive speed data is greater than a predetermined maximum time interval;
(b2) when the time interval between the successive speed data is greater than the predetermined maximum time interval, determining a distance between a last known position and a subsequent position.

11. The method of claim 10, wherein step (b) further includes the step of:
(b3) replacing the last known position with the subsequent position.

12. The method of claim 10, wherein step (b) further includes the steps of:
(b3) determining if the time interval between the successive speed data is greater than a predetermined minimum time interval and is not greater than the predetermined maximum time interval;
(b4) when the time interval between the successive speed data is greater than the predetermined minimum time interval and is not greater than the predetermined maximum time interval, averaging a last known position speed data with a subsequent position speed data to produce an average speed data.

13. The method of claim 12, wherein step (b) further includes the steps of:
(b5) multiplying the average speed data by the time interval between the successive speed data.

14. The method of claim 5, wherein step (b) includes the steps of:
(b1) receiving an engine signal;
(b2) determining if a time interval between a successive speed data is greater than a predetermined minimum time interval;
(b3) when the time interval between the successive speed data is greater than the predetermined minimum time interval, averaging a last known speed data with a successive speed data to create an average speed data;
(b4) multiplying the average speed data by the time interval between the last known speed data and the successive speed data to derive the odometer data.

15. The method of claim 14, wherein step (b1) includes the step of:
(i) receiving an engine on signal.

16. The method of claim 14, wherein step (b1) includes the step of:
(i) receiving an engine off signal.

17. A method of operating a virtual odometer system, comprising the steps of:
(a) receiving a plurality of speed data from a global positioning system receiver for each of a plurality of known time intervals; and
(b) when a time interval is not greater than a predetermined minimum time interval, processing a speed data for each of the plurality of known time intervals to create an odometer data.

18. The method of claim 17, wherein step (a) further includes the step of:
(a1) sending the plurality of speed data over a wireless communication system.

19. The method of claim 17, further including:
(c) sending an odometer data over a wireless communication system.

20. The method of claim 17 wherein step (b) further includes the following steps:
(b1) determining if a global positioning system receiver signal is lost;
(b2) when the global positioning system receiver signal is lost, determining when the global positioning system receiver signal is reacquired;
(b3) when the global positioning system receiver signal is reacquired, determining the distance between a last known position and a reacquired position.
